(19) United States
(12) Patent Application Publication
(10) Pub. No.: US 2005/0258809 A1
(43) Pub. Date: Nov. 24, 2005

(54) Control panel for pool

(76) Inventor: William R. Karslo, Horsham, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/080,783

(22) Filed: Mar. 15, 2005

Related U.S. Application Data
(60) Provisional application No. 60/553,170, filed on Mar. 15, 2004.

(51) Int. Cl. G05F 1/153

(52) U.S. Cl. 323/257

(57) ABSTRACT

A pool control panel has several features. First, the pool control panel is made from commercially available parts and components; nothing needs to be custom made, which makes for easy control panel maintenance. Second, the control panel has manual override switches for both the filter pump and the cleaner, in the event that the automatic timers fail. Third, the panel itself is preferably made from Grade 304 stainless steel, and thus avoids the rusting and corrosion common in steel control panels subject to weather and chlorinated water. Fourth, high pressure and high vacuum switches shut down the filter pump and cleaner in case of a pressure or vacuum emergency. Fifth, the control panel shuts down various accessories in response to motor overloads, faults, and/or wire surges.

### CROSS REFERENCE TO RELATED APPLICATION(S)

This application claims the benefit of U.S. provisional application No. 60/553,170 filed on Mar. 15, 2004, which is incorporated by reference as if fully set forth.

### FIELD OF INVENTION

The field of the invention is pool control panels that automate or manually operate various pool tasks, such as cleaning, filtration, heating, lighting, and other accessories.

### BACKGROUND

Pools require service and maintenance at regular intervals. Pool owners cannot always perform these tasks: sometimes the owner is out of town, other owners may not be able to physically perform the tasks, and others may be just plain forgetful. If the pool is neglected for any of these reasons, the pool may be damaged beyond reasonable repair. An automated control panel overcomes these problems by performing the routine pool maintenance while requiring minimal oversight from a pool owner.

These control panels face various safety obstacles. First, they are often custom made, so that failure of a part requires a long downtime while the part is remanufactured, or a specialized service technician is called to repair the control panel. Second, some control panels are so automated that failure of just a timer renders devices operated by the panel inoperable. Third, panels are usually exposed to year round weather, which means that the panels may see every weather type from Death Valley heat to Buffalo winters. Further, the electrical devices controlled by the panel are often wet or submerged in use, which provides additional risk to pool users if the devices allow electricity to flow into the water. Fifth, the panels also operate several electrical devices remotely, so that failure of a device, such as a heater, can cause serious damage to the pool or people in it, if the device is not shut down quickly. In general, most control panels automate only select features, have inadequate safety precautions.

### SUMMARY

The pool control panel described herein overcomes all of these shortcomings, and has many advantages. First, the pool control panel described herein is made from commercially available parts and components; nothing needs to be custom made, which makes for easy control panel maintenance. Second, the control panel has manual override switches for both the filter pump and the cleaner, in the event that the automatic timers fail. Third, the panel itself is preferably made from Grade 304 stainless steel, and thus avoids the rusting and corrosion common in steel control panels subject to weather and chlorinated water. Fourth, high pressure and high vacuum switches shut down the filter pump and cleaner in case of a pressure or vacuum emergency. Fifth, the control panel shuts down various accessories in response to motor overloads, faults, and/or wire surges. These features, and combinations thereof, are improvements over known control panels.

### BRIEF DESCRIPTION OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments, which are presently preferred. It should be understood, however, that the invention is not limited to the precise arrangements and instrumentalities shown. Further, in the drawings, certain notes and part designations have been inserted so that the drawings can be more easily understood. In the drawings:

FIG. 1 is an illustration of the exterior of a pool control panel;

FIG. 2 is an illustration of the interior of a pool control panel;

FIG. 3 is an illustration of the bottom of the pool control panel;

FIG. 4 is an illustration of the interior of the pool control panel; and

FIGS. 5 and 6 are wiring diagrams of a pool control panel.

### DETAILED DESCRIPTION OF THE PREFERRED EMBODIMENT(S)

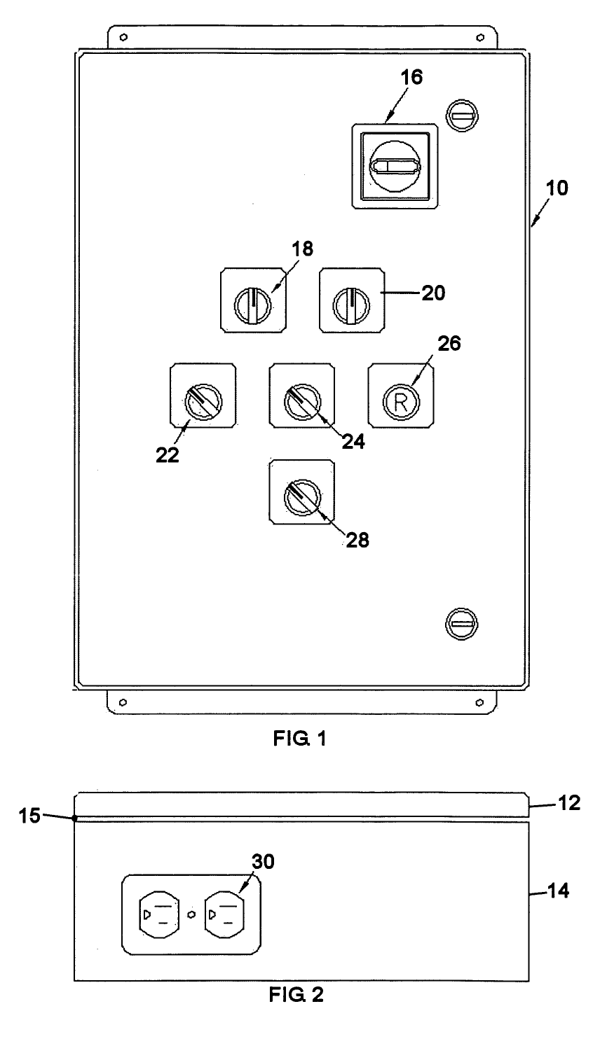

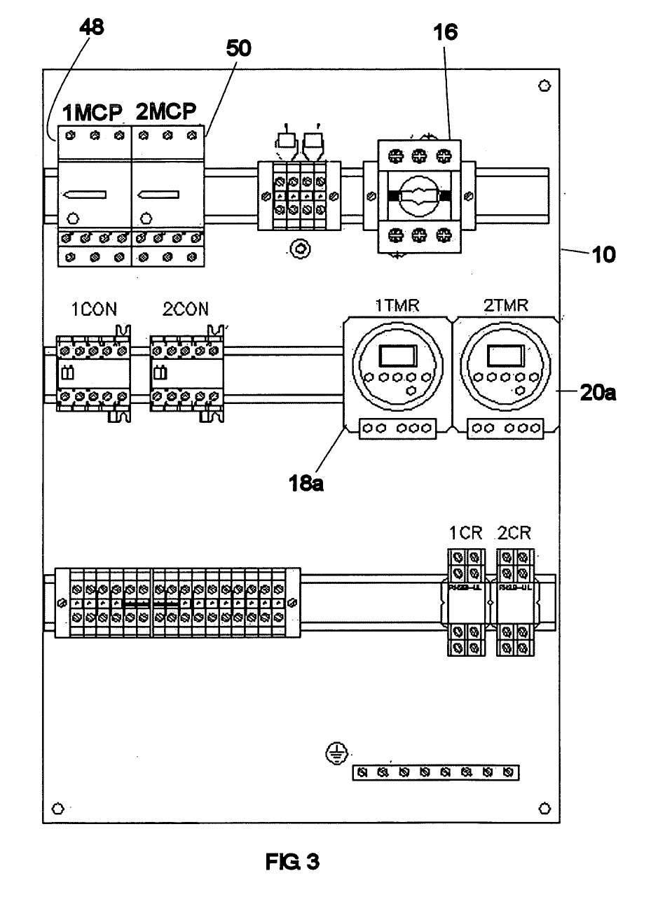

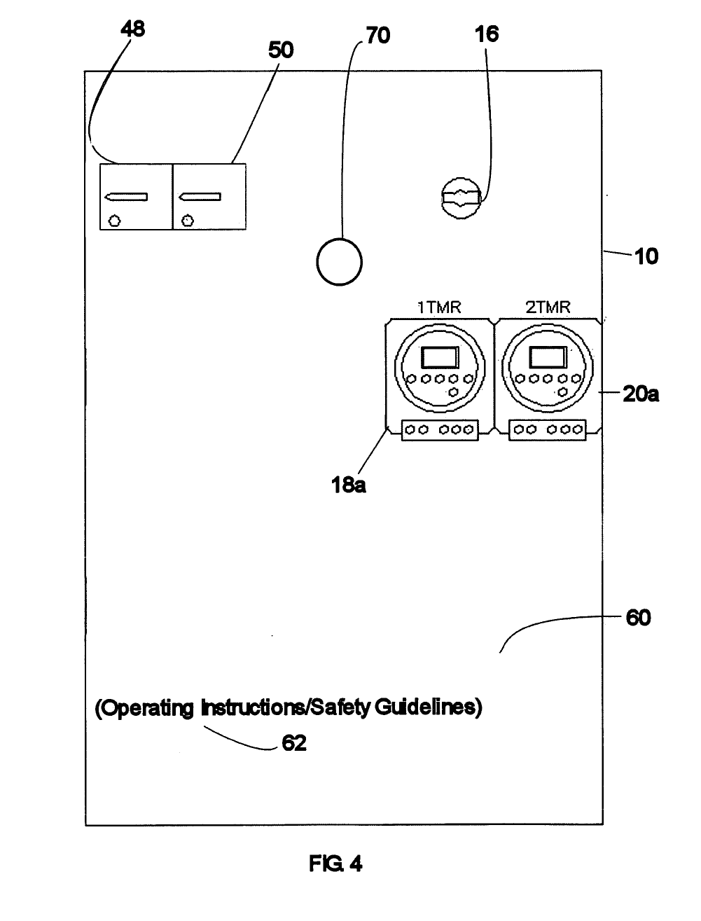

FIGS. 1-4 illustrate views of the control panel 10 that automates several pool functions. The control panel 10 is located remotely from the pool, between a power source (that enters the control panel 10 through an inlet) and electrical pool devices, so that all of the devices can be controlled at the control panel 10, which is remote from each of the individual pool devices.

The control panel 10 comprises a door 12 mounted to a hollow body 14 through a hinge 15. The door 12 closes and locks, latches, or is otherwise securely shut in a watertight seal. In this closed position, most of the control panel's functions can be controlled through manually operable waterproof switches. These switches are, as shown, (1) a main disconnect switch 16, (2) a filter control switch 18, (3) a cleaner control switch 20, (4) a pool light control switch 22, (5) a heater control switch 24, (6) a utility outlet control switch 26; and (7) an alarm reset button 28. A covered GFCI protected outlet 30 extends through a bottom panel 32, and can be easily accessed.

These switches all control various pool devices that perform maintenance functions. The main disconnect switch 16 controls the flow of electricity from the power source (usually within a house 100) to the control panel 10, which cuts power to all electrical devices on the same circuit as the control panel 10. The power can be interrupted by manually turning off the main disconnect switch 16, or if the main disconnect switch 16 is tripped. This main disconnect switch 16 is also preferably a lockable switch of the type sold as ABB OT32B2A1-180, which is a 40 Amp lockout disconnect. This lockout feature is especially useful for shutting down the system for long periods of time, such as during winter, or during extended pool maintenance.

A filter control switch 18 controls power to a pool's motor-operated filter 48a. The filter control switch 18 is a three way switch, with OFF, MANUAL, and AUTOMATIC positions. The OFF position cuts all power to the pool filter 48a, and as a safety feature, also cuts power to several of the other pool devices, such as the cleaner 50a, heater, and one of the GCFI protected sockets 30a. The MANUAL position closes a circuit, which not only powers the filter 48a, but also allows the other devices to be powered. The AUTOMATIC position runs the filter 48a according to a preset schedule programmed into a filter timer 18a located inside the control panel 10.

A cleaner control switch 20 controls power to a pool's motor-operated cleaner 50a. The cleaner control switch 20 is also three way switch, with OFF, MANUAL, and AUTOMATIC positions. The OFF position cuts all power to the cleaner 50a. The MANUAL position closes a circuit, which powers a cleaner 50a, as long as the filter 48a is powered. The AUTOMATIC position runs the cleaner 50a according to a preset schedule programmed into a cleaner timer 20a located inside the control panel 10; again as long as the filter is operating.

Both the filter and cleaner control switches 18, 20 are preferably backlit so they can be easily seen in the dark in their manual or automatic positions. The lit switches are easily seen and shutdown in case of an emergency.

The pool light control switch 22 is GFCI protected three way switch, and controls pool lighting, with two positions, ON and OFF. The ON position closes a circuit to power pool lights 22b. The OFF position opens the circuit and turns off the lights 22b. If the control panel 10 is wired for remote pool light control switch 22a, the remote switch 22a (located in a house, for example) controls power to the pool lights 22b. Because the switch 22 is a three way switch, the pool lights 22b can be controlled at either the pool light control switch 22 of the remote pool light control switch 22a.

The heater control switch 24 enables and disables a pool heater (not shown), so that when enabled, the pool heater can operate. In use, the heater is operated when the water in the pool reaches a certain minimum temperature; for this reason, the heater control switch 24 has an AUTO position instead of an ON position. Like the cleaner control switch 20, the pool heater cannot be operated unless the filter pump 48a is activated, which helps prevent heater burnout. The heater control switch 24 has an OFF position which opens a circuit and cuts power to the heater.

The GFCI protected electrical outlet 30 has two sockets, a first socket 30a, and a second socket 30b. The first socket 30a can be either always active (with the installation of a jumper 30c discussed below), or be active only when the a second contactor 2CON in the cleaner pump circuit is energized. When the first socket 30a is energized dependent on this second contactor 2CON, the socket 30a is effectively controlled by the cleaner pump switch 20 and timer 20a. This timing arrangement can be helpful for 120V cleaners. The first socket 30a would, like cleaner and heater above, be disabled if the filter was not activated, so that when the filter is disabled, an appliance plugged into the socket 30a would not run.

The outlet control switch 26 controls power to a second socket 30b of the GFCI protected electrical outlet 30. The outlet control switch 26 has OFF and ON positions, which correspond to an open circuit and a closed circuit. The outlet control switch 26 is particularly useful for landscape lighting, but could be used with any standard plug.

The alarm reset button 26 is a push-button that illuminates when enabled, to indicate an alarm. When the reset button is activated, several devices, including the filter pump, cleaner, and heater are shuts down.

The reset button 26 is activated for any one or combination of the following reasons: (1) filter or cleaner motor malfunction; (2) high pressure detection; and/or (3) high vacuum detection. While these conditions preferably activate to the reset button 26, other conditions can also activate the reset button in alternate embodiments, such as malfunction in the heater or outlet.

Once the reset button is activated, a person will usually check one of the following: checking the drain, clearing the filters, cleaning the skimmers, and if none of this works, resetting motor circuit protectors 48, 50. The reset button 26 can only be reset by manually depressing the reset button 26.

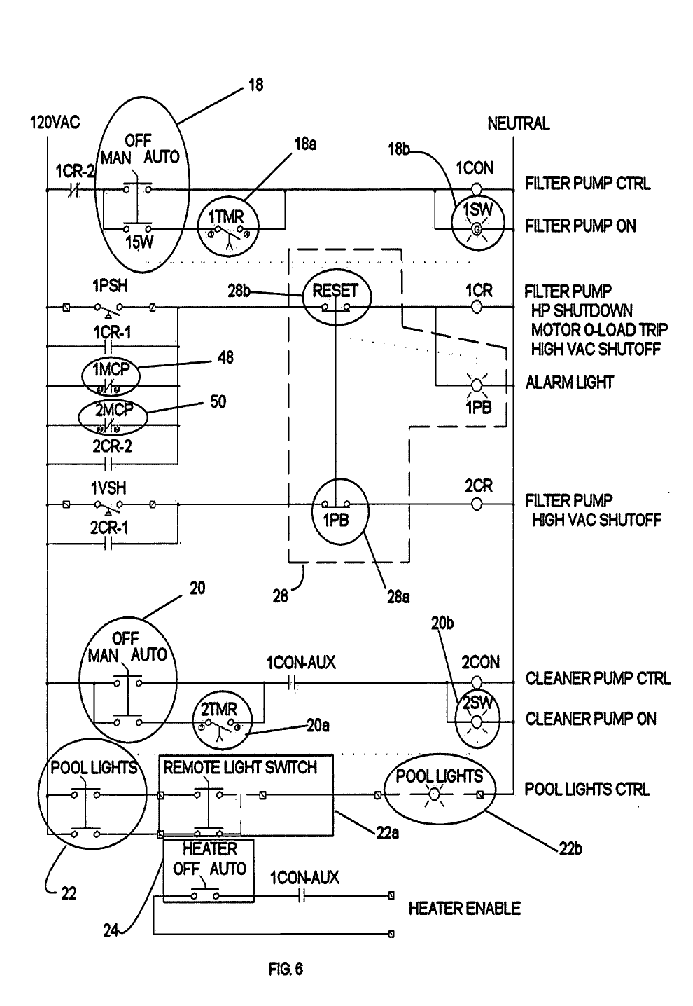

The wiring for the control panel 10 is mostly within the cavity of the hollow body 14, although some of it is located on the back of the door 12, running from the backs of the switches and over the inside of the hinge 15 into the cavity 14, and through the various components. For simplicity, the physical wires within the control panel 10 are omitted, but rather the wiring diagrams in FIGS. 5 and 6 schematically show the wiring. It is with reference to these wiring diagrams that the elements in FIGS. 1-4 are described.

FIGS. 5 and 6 show a presently preferred wiring diagram of the control panel, it being understood that the underlying logic could be programmed into a logic controller. Tracing the path of the electricity, 240V and 120V service from the house enters the control panel 10 through the 40 Amp main disconnect switch 16.

The 240 V feed is wired in parallel to the filter motor circuit protector 48 and cleaner pump motor circuit protector 50, both of which can be adjusted to trip at preferably between 10 and 16 Amps. 1CON and 2CON are contacts wired in series with the motor circuit protectors 48, 50, respectively, and are enabled when the contacts CON1 and CON2 are turned on (see lines 58 and 81); this logic will be discussed in more detail below. The filter pump and cleaner pump motors 48a, 50a, are part of each of the motor circuit protector circuits, although the motors themselves are located remote from the control panel 10. If either the motor circuit protector 48, 50 trips, due to a motor surge, which reflects a motor malfunction, the motors 48a, 50a turn off; tripping the motor circuit protectors 48, 50 activates the reset button 28 (see lines 66 and 68 in FIG. 6) which causes a system shutdown and activation of the reset button 28. How this results in a the reset button 28 being activated is discussed in more detail below.

At line 28, a motor surge suppressor 52 would consume to its rating, and then disable in reaction to line surge, which also trips entire circuit and shuts down all the control panel accessories.

The 120V feed powers the remainder of the control panel circuit from lines 33 to 94. A surge suppressor 54 is wired in parallel to the circuits shown on lines 33-94. As above, should this surge suppressor 54 disable, it will shut down the entire circuit.

Starting at line 35 in FIG. 5, the outlet 30 has two sockets, 30a and 30b. The first socket 30a is either always enabled when jumper 30c is installed, or, if the jumper 30c is removed, only enabled when the second contactor 2CON (see line 81 in the cleaner circuit), is turned on. Socket 30b is controlled by the outlet control switch 26 as described above.

At lines 40-48, the 120V feed supplies the timers 18a, 20a, which are preferably 7 day/24 hour cycle timers having a battery backup so they do not lose time during a power interrupt.

FIG. 6, lines 54-58 show the filter control switch 18 and filter control timer 18a. The filter control switch 18 is wired in series after the normally closed second pole of the first control relay switch 1CR-2. Electricity passing through this switch goes to the filter control switch 18, which has three positions discussed generally above: OFF, MANUAL, and AUTOMATIC. In the OFF position, the circuit along line 58 is broken and the first contactor 1CON is not turned on, which breaks the motor circuit at lines 15 and 18, which in turn shuts down the filter pump motor 48a. In the MANUAL position, the circuit is closed and CON1 is turned on, which enables both 1CON (see lines 15 and 18), closing the filter pump motor circuit (lines 15-18), and 1CON-AUX, which closes both the cleaner circuit (lines 81-83) and the heater circuit (lines 92-94). In the MANUAL position, the circuit powers the filter pump running light 18b. In the AUTOMATIC POSITION, the circuit closes through the filter timer 18a, and if the timer 18a is closed (during active times set by the user), the circuit follows the same path as in MANUAL, and if the timer 18a is open (during inactive times set by the user), circuit follows the same logic as in the OFF position.

Lines 81-83 show the cleaner control switch 20 and filter control timer 20a. The cleaner control switch 20 has three positions discussed generally above: OFF, MANUAL, and AUTOMATIC. In the OFF position, the circuit along line 81 is broken and the second contactor 2CON is not turned on, which breaks the circuit at lines 22, 25, and 35, which in turn shuts down the cleaner pump 50a and the cleaner socket 30a. In the MANUAL position, the circuit is closed through the second contact CON2. Turning on the contact CON2 enables 2CON at lines 22-25, enabling the cleaner motor circuit (lines 22-25), and 2CON at line 35 enabling the cleaner circuit through the socket 30a, if a 120V cleaner is being used. Further, in the MANUAL position, the circuit powers the cleaner running light 20b. In the AUTOMATIC POSITION, the circuit closes through the cleaner timer 18a, and if the timer 20a is closed (during active times set by the user), the circuit follows the same path as in MANUAL, and if the timer 20a is open (during inactive times set by the user), circuit follows the same logic as in the OFF position. As a safety feature, and as discussed above, the cleaner pump circuit cannot be enabled unless 1CON is turned on because this closes the cleaner pump circuit at 1CON-AUX; in operation, this means that the cleaner pump cannot be operated if the filter pump is off.

Lines 87-89 show that the pool light control switch 22 and optional remote pool light switch 22a controls the pool lights 22b (located remote from the control panel 10). If either switch is set to OFF, the pool light circuit is open and the pool lights 22b will not turn on. If the pool light control switch 22 is set to REMOTE, and the remote pool light switch is ON, the pool lights will turn on. Likewise, if the remote pool light switch 22a is not installed, turning the pool light switch 22 to REMOTE will turn on the pool lights 22b.

Lines 92-94 show how a heater, which is not used in every pool, would be wired into the control panel 10. As a safety feature, and as discussed above, the heater circuit cannot be enabled unless 1CON is turned on because this closes the heater circuit at 1CON-AUX; in operation, this means that the heater cannot be turned on if the filter pump is off. The heater control switch has OFF and AUTO settings. The OFF setting is explanatory. In the AUTO position, the heater can be turned on, if the water temperature is below a preset temperature.

Lines 62-74 summarize the reset button 28's circuit. The reset button 28 comprises the push button reset 28a and the circuit reset 28b, both of which are normally open. In operation, when the reset button 28 is activated, the push button 28a must be depressed in order to re-energize the system.

The reset circuit comprises several components, each of which will be introduced before their relationship to each other is described. First, an optional but preferred normally open high pressure switch 1PSH can be closed upon receipt of a signal at the filter pump that the pressure has spiked, which indicates a problem. The following components are wired in parallel to the high pressure switch 1PSH: (1) the normally open first pole of the first control relay switch 1CR-1 that is closed when control relay 1CR is turned on, (2) and (3) the motor circuit protectors 48, 50, and (4) a normally open second pole of a control relay switch 2CR-2 activated by the second control relay 2CR.

Another optional but preferred normally open high vacuum switch 1VSH can be closed upon receipt of a signal at the cleaner that the vacuum has spiked, which indicates a problem, likely a blockage. The normally open first pole of the second control relay switch 2CR-1 is wired in parallel to the vacuum switch 1VSH, and the relay switch 2CR-1 is closed when the control relay 2CR is turned on.

The component of the reset circuit is the alarm light 1PB, which is visible through the translucent push button 28, when the push button reset is activated.

In operation, the reset circuit operates as follows. First, any closure of the circuit through any of the high pressure switch 1PSH, the first pole of the first control relay 1CR-1, the filter motor circuit protector 48, the cleaner motor control protector 50, or the second pole of the second control relay switch 2CR-2 turns on the control relays 1CR and 2CR through the activation of push button reset 28a and circuit reset 28b.

The control relays 1CR and 2CR activate several control relay switches. First, the first control relay 1CR opens the normally open second pole of control relay switch 1CR-2, which breaks the filter circuit (lines 56-58), and as a consequence, the filter motor circuit (lines 15-18), the cleaner pump circuit (lines 81-83), the heater circuit (92-94), the cleaner motor circuit (lines 23-25), and the 120V cleaner socket 30b circuit (line 35), shutting down all of the associated devices. Second, the first control relay 1CR closes the first pole of the first control relay switch 1CR-1, which latches the circuit so that the alarm light 1PB remains lit, and the circuit reset 28b and push button 28a remain activated until the push button is manually depressed. This latching prevents the system from reenergizing without human intervention. In practice this means that the cause of the pressure increase or component problem must be addressed before the system can be reenergized. Third the second control relay 2CR closes the first pole of the second control relay switch 2CR-1, which again acts to latch the system in its active state as described above.

Manually resetting the system, turns off the control relays 1CR and 2CR and reenergizes all the associated circuits, as long as the problem has been cleared.

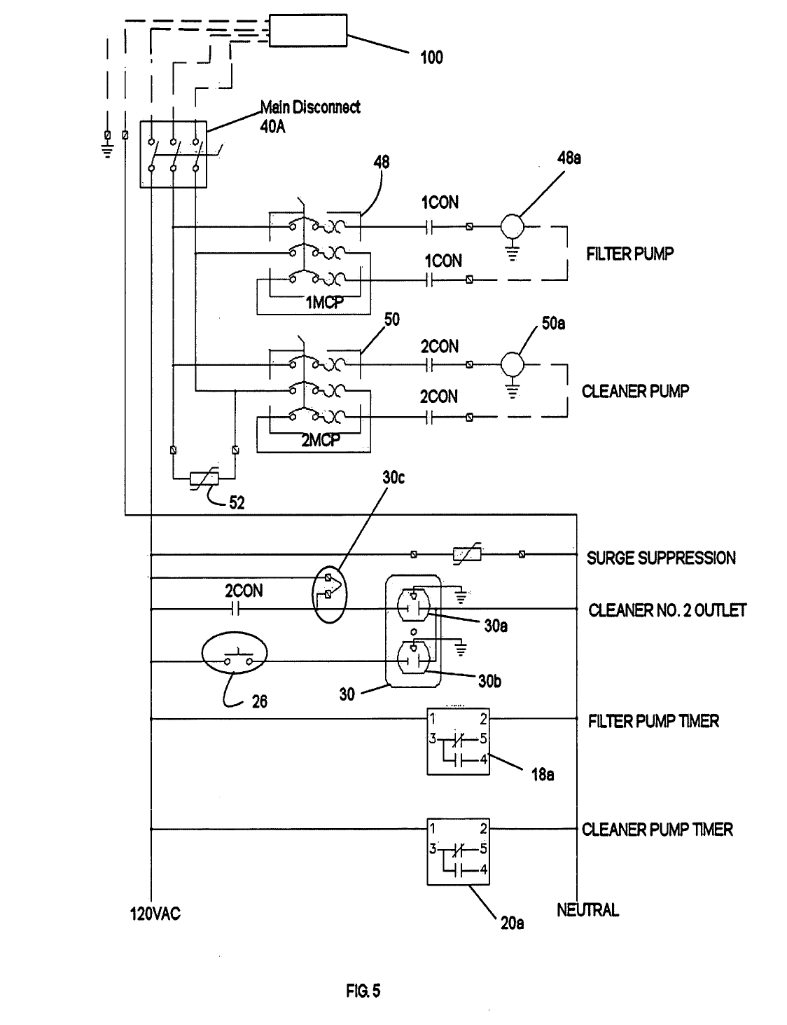

FIG. 4 shows an additional safety improvement of the panel, in which only the timers 18a, 20a, main disconnect 16, and motor circuit protectors are accessible, while the remainder of the hollow cavity is covered by a protective cover 60, on which instructions 62 regarding the operation of the panel are written. The protective cover 60 is prefereably held in place by a removable knob (or knobs) 70.

The control panel can be adapted with other switches and outlets, such as to control spa jets, additional lighting outside the pool, a pool alarm, water valves for filling the pool, and the like.

Further, although FIGS. 1-4 show a preferable arrangement of the components of the control panel, this is in now way limiting to other arrangements, and it should be understood that common components like a terminal block and ground bars are not described herein as they would be known to one of ordinary skill.

1. A control panel for controlling pool functions comprising:
a power inlet through which electricity flows to the control panel;
a filter control switch that can be closed or open, wherein closed and open correspond to MANUAL and OFF positions respectively, wherein in the MANUAL position, electricity from the power inlet flows through the filter control switch to an electric pool filter located outside the control panel, wherein in the OFF position, electricity from the power inlet cannot flow through the filter control switch to the electric pool filter; and
a cleaner control switch that is wired in parallel to the filter switch, the cleaner switch can be closed or open, wherein closed and open correspond to MANUAL and OFF positions respectively, wherein in the MANUAL position, electricity flows through the cleaner switch to a cleaner located outside the control panel, wherein in the OFF position, electricity from the power inlet cannot flow through the cleaner control switch to the cleaner;
wherein when the filter control switch is in the OFF position, electricity cannot flow through the control panel to the cleaner.

2. The control panel of claim 1, wherein if electricity does not flow through the filter control switch, electricity cannot flow through the control panel to the cleaner.

3. The control panel of claim 1, wherein the filter control switch further comprises an AUTO position, wherein in the AUTO position, the flow of electricity from the power inlet to the electric pool filter is determined by a filter timer; and
wherein the cleaner control switch further comprises an AUTO position, wherein in the AUTO position, the flow of electricity from the power inlet to the cleaner is determined by a cleaner timer.

4. The control panel of claim 1, wherein the filter control switch and cleaner control switch are backlit.

5. The control panel of claim 2, further comprising a reset button, wherein the reset button is activated in response to at least on of an emergency conditions including:
a malfunction of the filter;
a malfunction of the cleaner;
a high pressure condition in the pool; or
a high vacuum condition in the pool;
wherein, in response to one of the conditions, the reset button is activated, the reset button becomes lit, and electricity from the power inlet cannot flow through the filter control switch to the filter.

6. The control panel of claim 5, wherein, when the reset button is activated, the reset button must be physically depressed to inactivate the reset button, which in turn restores the flow of electricity from the power inlet through the filter control switch, to the filter.

7. The control panel of claim 6, wherein the reset button is backlit when activated.

8. The control panel of claim 1, wherein a pool heater circuit supplies power to a pool heater, and wherein the pool heater circuit cannot be enabled unless electricity from the power inlet is flowing through the cleaner control switch to the cleaner.

9. The control panel of claim 1, further comprising a GFCI outlet having a first socket, wherein if electricity does not flow through the cleaner control switch, electricity cannot flow through the first socket.

10. The control panel of claim 1, further comprising:
a filter motor circuit protector having an open and closed position, wherein in the open position, electricity from the power inlet flows through the filter motor circuit protector to a filter motor, wherein the filter motor circuit protector will trip to its open position upon an overload through the filter motor circuit protector.

11. The control panel of claim 10, further comprising:
a cleaner motor circuit protector having an open and closed position, wherein in the open position, electricity from the power inlet flows through the cleaner motor circuit protector to a cleaner motor, wherein the cleaner motor circuit protector will trip to its open position upon an overload through the cleaner motor circuit protector.
